(19) United States
(12) Patent Application Publication
(10) Pub. No.: US 2004/0089833 A1
(43) Pub. Date: May 13, 2004

(54) Sealed-off switchgear

(76) Inventors: Michael Muller, Bexbach (DE); Heinz Jacobus, Dudweiler (DE); Matthias Stitz, Lohr (DE); Bruno Schneider, Fellen (DE)

Correspondence Address: Mark S Bicks, Roylance Abrams Berdo & Goodman, Suite 600, 1300 19th Street NW, Washington, DC, 20036, US

(21) Appl. No.: 10/470,973

(22) PCT Filed: Jan. 24, 2002
(86) PCT No.: PCT/EP02/00677

(30) Foreign Application Priority Data
Feb. 3, 2001 (DE) 101 04 998.6

(51) Int. Cl. H02K 41/00; F16K 31/02; H01F 3/00

(52) U.S. Cl. 251/129.15; 310/14; 335/255

(57) ABSTRACT

The invention relates to a switchgear, especially for actuating valves, comprising a housing (18) and a coil body (10) disposed therein in which a switch element is guided and which is provided with a winding (14) of a conductor (16) that is connected to a plug connector (22) via contact elements (20). At least some sections of the housing (18) and of the plug connector (22) are enclosed by a plastic compound (24), and sealing devices (40) seal off the interior (42) of the switchgear from the surroundings (44). At least one of the sealing devices (40) is configured as a sealing web (48), said sealing web (48) consisting of a meltable material. The sealing web (48) is disposed on the bottom face (50) of a plug plate (26) of the plug connector (22) which faces the housing (18). The sealing web (48), in the molten connection state, seals off at least the engaging parts of the plug connector (22) that are connected to the housing (18) from the surroundings (44) in a fluid-tight manner by way of the plastic compound (24), thereby eliminating the need for conventional rubber packing rings (O rings) in the area of the plug connector that are prone to failures.

The invention relates to a sealed-off switchgear, especially for actuating valves, comprising a housing and a coil element mounted in this housing, in which a switching component is conducted and is provided with a winding of a conductor which is connected to the contact components of an attaching plug, with at least some parts of the housing and of the attaching plug being surrounded by a plastic material and means sealing the interior of the switching device from the environment.

Switching devices such as those referred to, which in technical language are also designated as switching magnets, are disclosed, for example, in DE 36 35 551 A1 and DE-GM 83 17 753 and are readily obtainable on the market. The switching component is made up essentially of a tubular bolt which, when the coil undergoes electric excitation, traverses a predetermined path to the plug receptacle of a connector plate, thereby initiating a switching process, for example, in the case of a valve blocking and allowing the passage of fluid flows. If such disclosed switching devices are used in areas of high humidity such as occurs among other situations in formation of condensate, the moisture advances to the interior of the housing, and especially to the coil element with the winding, and there leads to disabling of the switching device as corrosion occurs. While it has already been proposed that this problem be circumvented by enclosing the housing of the switching device entirely in a plastic sealing compound providing protection from moisture, this measure results in an overly large switching device ill suited for use in automotive technology (mobile technology), where in essence only little installation space is available.

The proposal has been made in accordance with FR 1 348 792 that rubber sealing rings (O rings) mounted on the end in seats of housing covers of the switching device and between the housing and the plug receptacle of the connector plate be used to effect sealing potential points of entry of moisture into the housing rather than sealing by way of a plastic sealing compound. In this instance as well, however, it has been found that the effect of sealing from penetration of moisture, in particular in the area of the plug connector of the connector plate, is not satisfactory and that embrittlement of the sealing rings which may accompany aging of the switching device results in complete destruction of the sealing effect.

Another magnetic coil configuration is disclosed in DE 198 54 100 A1; it consists of an encapsulated coil with a spray-applied plug socket for connection of electric connection leads and a metal housing enclosing the encapsulated coil. The contact lug associated with the protective lead connection extends through the plug socket and is connected to the metal housing. In order to prevent entry of moisture into the sealed space of the plug socket as a result of capillary action between the contact lug and the plastic enclosing it, there is provided between the plug socket and the outer surface of the encapsulated coil a recess into which the metal housing is introduced. A connecting element which effects electric connection of the contact lug with the metal housing extends through the recess inside the plug socket. A sealing element enclosing the connecting element is mounted in the recess in the plug socket. Magnetic coil configurations such as this are employed in industrial hydraulics for actuation of electromagnetically operated hydraulic valves in which metal parts accessible from the exterior are to be connected to a grounded lead connection.

In the case of generic a switching device disclosed in DE 43 41 087 C2 an attempt has been made to solve the problem described in the foregoing in that the plug receptacle in question has for application of an annular sealing component a contact surface which projects a predetermined axial distance beyond the bottom of the connector plate facing the external circumference of the housing, in such a way that, when installation has been completed, at least the gap between connector plate and the external circumference of the housing is closed to effect sealing by applying pressure to the annular rubber sealing element, so that in this way moisture can no longer reach the interior of the housing, and in particular the coil element with the winding. The respective solution is costly to implement, however, and the parts in question must interact with minimal tolerances, something which appreciably increases manufacturing complexity and consequently manufacturing costs. In addition, since a rubber sealing ring is used, when the switching device is in service over a long period failure from embrittlement or loosening of the sealing ring in question cannot be excluded.

On the basis of this state of the art the invention has the object of developing a compact switching device which is suitable in particular for use in automotive technology and which nevertheless permits a long period of reliable operation even in high humidity.

This object is attained by a switching device having the characteristics specified in claim 1 in its entirety.

In that, as specified in the preamble of claim 1, at least one of the sealing means is in the form of a sealing strip, that the sealing strip consists of a fusible material, that the sealing material when applied is at a temperature such that the sealing strip in question melts with the plastic material to effect sealing from fluids, that the sealing strip is mounted on the bottom of a plug receptacle of the plug connector facing the housing, and in that the sealing strip seals fluid tight from the environment, when melted and joined with the plastic material, at least the contact components of the plug connector connected to the housing, the use of conventional rubber sealing rings (O rings) subject to failure may be completely eliminated in the areas of the plug connector. Thermal fusion of the sealing strip to the plastic sealing compound results in homogenous fusion of material components facing each other, something which ensures dependable sealing of the operating parts from the environment even in high humidity or penetration by condensate and thus ensures dependable operation of the switching device even over very long periods of use. Since, in addition, the sealing strip is distinctly compact, the sealing strips produced themselves occupy no structural space or only a small such space, so that the sealing sections produced are themselves in turn small or occupy only a small structural space, so that the switching device as a whole or the switching magnet may be configured to be structurally small. Since the switching device in any event is extrusion-coated with the plastic sealing compound, sealing of the device by the extrusion coating proper or casting integral with the plastic compound can be accomplished in one process step, something which appreciably simplifies production and lowers production costs. Consequently, the costly additional insertion of sealing rings and precise positioning of these rings inside the switching device in the area of the attaching plug may be completely eliminated.

The sealing strip is mounted on the bottom of a connector plate of the attaching plug facing the housing; the sealing strip at least of the contact components of the plug connector which are connected to the housing when in the melted connection state with the plastic compound effect fluid-tight sealing from the environment. The sealing ring preferably is a one-piece component of the plug receptacle. This provides a reliable, simple sealing option without the need for first carrying out precise adjustment steps for axial pressing of the conventional rubber sealing rings to the bottom of the plug receptacle as in the state of the art described in DE 43 41 087 C2.

In that in this way free space or a gap exists between the sealing strip and the housing or between the housing and the attaching plug, and in that in extrusion coating by means of the hot plastic compound the latter reaches the sealing strip unimpeded and flows around it on all sides until it is sealed off, improved flow behavior is achieved for the plastic compound itself in jacketing of the switching device or essential parts of the latter, and this in turn is favorable from the viewpoint of manufacturing technology. In any event, the use of additional sealing means in the form of rubber sealing rings or the like may be dispensed with as a result of the sealing strip in the form of the fused strip in conjunction with the process of fusion with hot plastic compound.

Additional advantageous configurations are described in the other dependent claims.

One exemplary embodiment of the switching device claimed for the invention is now explained in what follows with reference to the drawing, in which, in diagrammatic form not drawn to scale,

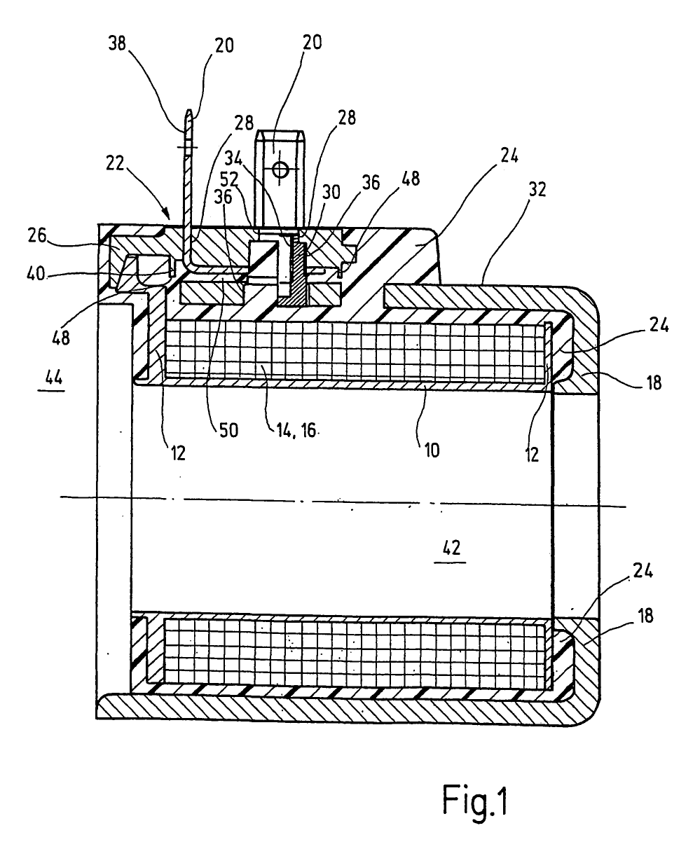

FIG. 1 illustrates a longitudinal section of the switching device without polar tube and without switching component, the fusion strip being shown appreciably enlarged;

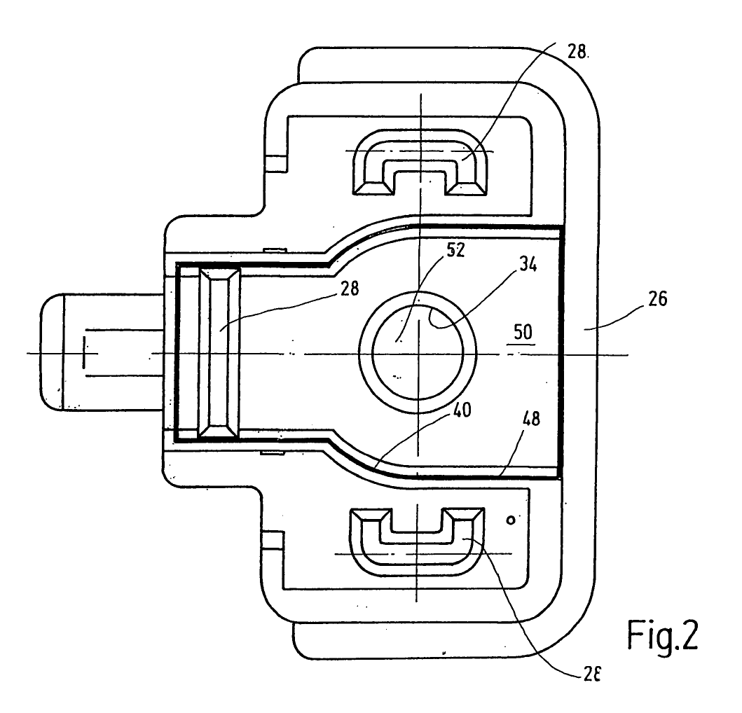

FIG. 2 a bottom view of a plug component of the attaching plug with no plug components introduced.

The switching device has a coil element 10 of plastic material. The coil element 10 has on the end two annular frontal flanges 12 between which extends the winding stack 14 of a conductor 16 which in FIG. 1 is shown only in diagrammatic form. There is introduced into the coil element 10 a switching component (not shown) which is surrounded by a so-called polar tube (not shown). The configuration in question is of the state of the art, and accordingly will not be discussed in greater detail at this point. However, the switching component may be used in actuation of the switching device to operate conventional valves and thus to determine their switched position.

The coil element 10 is enclosed in a more or less cylindrical housing 18 of a metal material. The conductor 16 of the winding 14 is in contact with contact components (20) in the form of three plug lugs of an attaching plug 22 so as to conduct electricity. The details of the respective connection technology between the conductor 16, the winding 14, and the electrically conducting components of the attaching plug 22 are presented in particular in FIG. 2 of DE 43 41 087 C2 and accordingly will not be discussed in greater detail at this point.

A plastic compound 24, especially one in the form of a plastic sealing compound, is employed for electric insulation of the parts of the housing 18, the winding 14, and conducting parts of the plug connector 22. This compound may be injected at an elevated temperature into the gaps between the parts in question and sets there. An integral casting or integral extrusion mold (not shown) into which the parts of the switching device may be introduced serves the purpose of integral extrusion of the switching device itself with the plastic compound 24.

The contact components 20 in the form of the three plug lugs may be cut or stamped from a level blank and are then integrally molded with the plastic material of the connecting plug 22 in the form of the plug receptacle 26. The respective plug receptacle 26 is shown in FIG. 2 as seen from the bottom, the plug lugs being omitted for the sake of greater simplicity of illustration and only the three openings 28 in the plug receptacle 26 being shown through which extend the contact components 20 in the form of the plug lugs. The plug receptacle 26 has more or less in the center a connection insert 30 which is in the form of a kind of bushing. By means of this connection insert 30 the plug receptacle 26 may be positioned on the external circumference 32 of the housing 18 with proper spacing maintained. In addition, the connection insert 30 has an internal screw thread 34 and two edge inserts 36 axially spaced from each other each of which is provided with longitudinal teeth. The edge inserts 36 in question ensure firm holding of the connection insert 30 both in the metal housing 18 and in the plug receptacle 26 by its plastic material.

The internal screw thread 34 is part of a screw connection into which the plug receptacle 26 is introduced for the purpose of current connection together with an appliance plug (not shown). The connection insert 30 is connected to the contact component 20 of the plug receptacle 26 serving as ground connection 38 and in particular extends conductively through the ground connection 38 in question. In order to effect connection of the plug receptacle 26 to the housing 18, preferably the connection insert 30 is first introduced into the plug receptacle 26 and is then pressed together with it against the housing 18 at least until secure retention of the lower part of the edge insert 36 in the housing 18 is ensured. The housing 18, the coil element 10, and the winding 14 are configured as more or less rotation-symmetrical components and the plastic sealing compound 24 is shown crosshatched in FIG. 1 and indicates the compound-filled spaces and gaps in the switching device. In addition to electric insulation, the plastic compound 24 in essence also ensures that moisture, in the form of condensate or the like, cannot penetrate the switching device. The possibility is not to be excluded, however, that moisture may penetrate the switching device as a result of capillary action which occurs in particular between the connecting surface of the plastic compound 24 and the other parts of the switching device such as the housing 18 or the parts of the plug receptacle 26. Additional sealing means 40 which seal the interior 42 from the environment 44 (see FIG. 1) are provided to remedy the problem of the capillary action in question.

The sealing means 40 in question is made up of a sealing strip 48, this sealing strip 48 consisting of a fusible material and when the plastic compound 24 is applied this material is at a temperature such that the respective sealing strip 48 fuses fluid-tight with the plastic mass 24. In order to permit illustration of the sealing strip 48, the latter is shown graphically in FIG. 1, although the plastic mass 24 has in this situation already been introduced into the switching device proper. The sealing strip 48 accordingly forms a closed sealing ring with the plastic compound 24 itself in advance of the fusion.

The sealing strip 48 is mounted on the bottom 50 of the plug receptacle 26 of the attaching plug 22 facing the housing 18. This sealing strip 48 seals at least the contact components connected to the housing 18 of the attaching plug 22 in the form of the sleeve-like connection insert 30, when in the fused connection state with the plastic compound 24, fluid-tight from the environment 44. As is shown by FIG. 2 in particular, the sealing strip 48 is an integral component of the plug receptacle 26 and projects a predetermined distance beyond the bottom 50 of this plate. As is shown by FIG. 2 in particular, the sealing strip 48 is in the form of a sort of circumferential sealing edge, the sealing strip 48 being self-contained and including between its sealing edges the boring 52, which later receives the connection insert 30 when assembly has been completed. In addition, the sealing strip 48 separates the respective connection insert 30 from the two current-conducting lugs as contact components 20, while the ground connection 38 is situated inside the sealing strip 48 and there extends through the associated opening 28. To this extent also separation of the ground connection 38 from the two current-conducting contact plugs 20 is effected by way of the sealing edge in the form of the sealing strip 48. The sealing strip in question is in the form of a fused ring or fused strip which melts as soon as it comes in contact with the hot integrally extruded compound and forms an integral connection with the plastic compound 24. The sealing strip 48 is accordingly by preference also made up of a thermoplastic material similar to the plastic compound 24 and consists preferably of a polyamide material.

As the illustrations show, the sealing strip 48 may be rectangular in cross-section; however, a triangular cross-sectional shape or other cross-sectional shapes (not shown) are also possible without impairing the sealing effect. In addition, the sealing strip 48 selected may be configured to be structurally very small, for example, they may be of a width of 0.2 to 0.3 mm and of a height of 0.3 to 0.4 mm.

In particular the materials selected are to be such that, for example, the plastic of the coil element 10 has a melting point lower than that of the plastic compound 24, so that melting on the sealing strip 48 is in any event ensured by the integrally extruded compound. The same applies to selection of the plastic for the attaching plug 22.

1. A sealed-off switchgear, in particular for actuation of valves, with a housing (18) and a coil element (10) mounted therein in which a switching component is conducted and which is provided with a winding (14) of a conductor (16) which is connected to contact components (20) of an attaching plug (22), at least parts of the housing (18) and of the attaching plug (22) being enclosed in a plastic compound (24) and sealing means (40) sealing the interior (42) of the switching device from the environment (44), characterized in that at least one of the sealing means (40) is in the form of a sealing strip (48) of a fusible material, in that the sealing strip (48) is mounted on the bottom (50) facing the housing (18) of a plug receptacle (26) of the attaching plug (22), and in that the sealing strip (48), when in the fused connection state with the plastic compound (24), seals off at least the contact components of the attaching plug (22) which are connected to the housing (18) fluid-tight from the environment (44).

2. The switching device as claimed in claim 1, wherein the sealing strip (48) forms a closed ring with the plastic compound (24) in advance of fusion.

3. The switching device as claimed in claim 1 or 2, wherein the sealing strip (48) is an integral component of the plug receptacle (26).

4. The switching device as claimed in one of claims 1 to 3, wherein the sealing strip (48) consists of thermoplastic material.

5. The switching device as claimed in one of claims 1 to 4, wherein the sealing strip (48) is rectangular or triangular in cross-section.

6. The switching device as claimed in one of claims 1 to 5, wherein the plastic compound (24) may be applied by integral extrusion and consists in particular of a thermoplastic such as a polyamide.
